(19) United States
(12) Patent Application Publication
(10) Pub. No.: US 2011/0231526 A1
(43) Pub. Date: Sep. 22, 2011

(54) ACCESS POINT DEVICE AND MONITOR SYSTEM USING THE ACCESS POINT DEVICE

(75) Inventor: Ming-Chih Hsieh, Tu-Cheng (TW)

(73) Assignee: HON HAI PRECISION INDUSTRY CO., LTD., Tu-Cheng (TW)

(21) Appl. No.: 12/826,621

(22) Filed: Jun. 29, 2010

(30) Foreign Application Priority Data
Mar. 17, 2010 (TW) 99107727

(51) Int. Cl. G06F 15/177; G06F 15/16

(52) U.S. Cl. 709/220; 709/224

(57) ABSTRACT

A monitor system includes at least one network camera distributed in an area to be monitored, an access point device connected to the at least one network camera. The access point device includes ports, a central processing unit (CPU), and a storage device containing an information table. Each of the ports is connected to the CPU, and the CPU is connected to the storage device. The table records a serial number, a media access control (MAC) address, and an area monitored by each camera in the system, and records an Internet protocol (IP) pool previously assigned to each monitored area. After an IP request from one of the cameras, the CPU searches an associated IP pool in the table according to the MAC address, and randomly assigns an IP address from the IP pool to a corresponding network camera.

### BACKGROUND

1. Technical Field

Embodiments of the present disclosure generally relate to monitor technologies, and more particularly to an access point device and a monitor system using the access point device.

2. Description of Related Art

Network cameras are commonly used in a monitor system. When multiple network cameras are used in the monitor system, each of the network cameras may be assigned an Internet protocol (IP) address for distinguishing them apart. As shown in FIG. 1, a monitor system 100 includes network cameras 2, an access point (AP) device 1, and a monitor device 3. The AP device 1 includes a plurality of ports 10 and a central processing unit (CPU) 12. The CPU 12 assigns an IP address to each of the network cameras 2 by using a dynamic host configuration protocol (DHCP) method. For example, the CPU 12 of the AP device 1 previously assigns an IP pool (such as “192.168.1.***”), and uses the DHCP method to randomly assign an IP address from the IP pool to each of the network cameras 2. However, because the IP address of the network cameras 2 are all from one IP pool, the network cameras 2 distributed in different areas are not easily identified by the AP device 1 according to the assigned IP address.

What is needed, therefore, is an improved monitor system to overcome the limitations described.

### BRIEF DESCRIPTION OF THE DRAWINGS

FIG. 1 is a block diagram of a traditional monitor system.

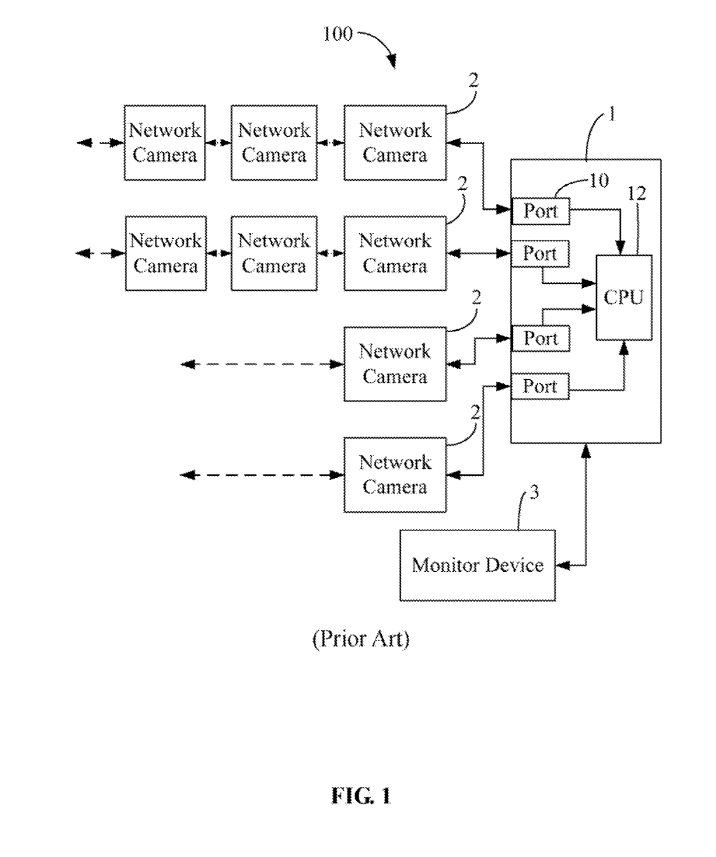

FIG. 2 is a block diagram of one embodiment of a monitor system including an access point device and a plurality of network cameras.

FIG. 3 is a block diagram of one embodiment of a network camera having a switch.

FIG. 4 is a flowchart illustrating one embodiment of a monitor method using the monitor system of FIG. 2.

FIG. 5 is a schematic diagram illustrating an exemplary table.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

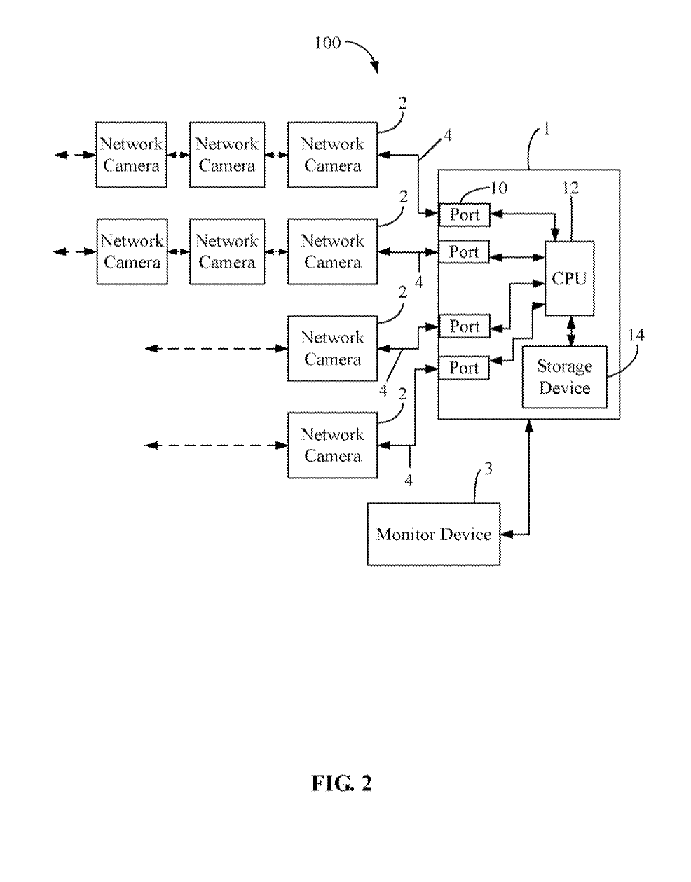

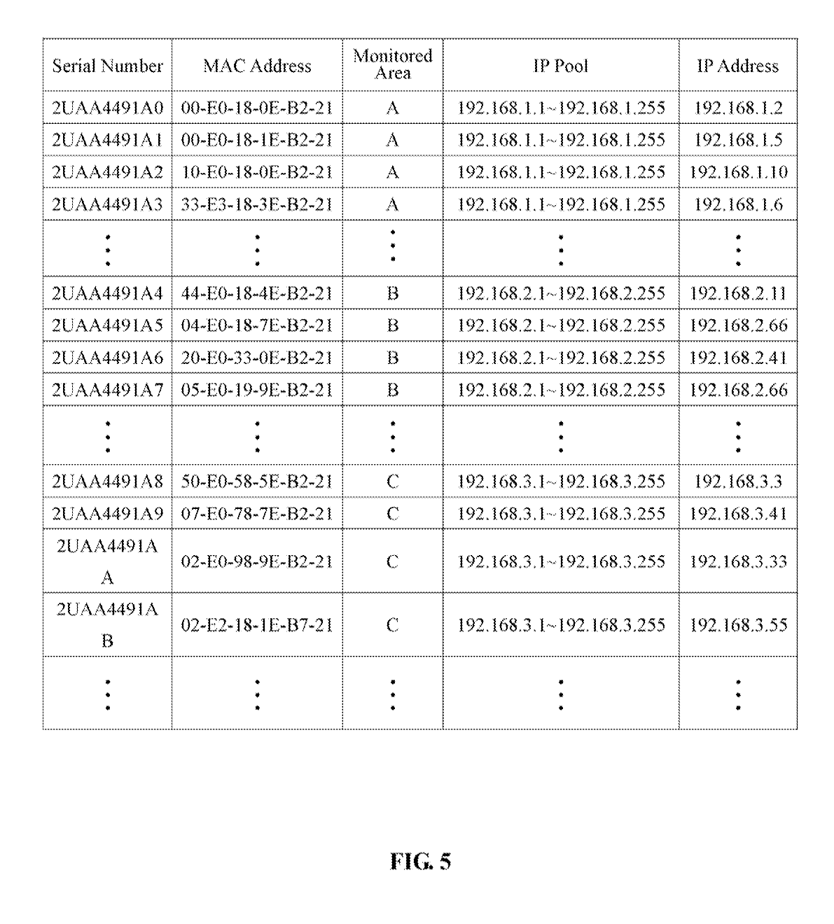

FIG. 2 is a block diagram of one embodiment of a monitor system 100. In the embodiment, the monitor system 100 includes an access point (AP) device 1 and a plurality of network cameras 2. Each of the network cameras 2 is distributed in an area to be monitored, and configured for capturing images of the monitored area. The network cameras 2 in a single monitored area are connected in series. The AP device 1 is connected to the network cameras 2. The AP device 1 includes a plurality of ports 10, a central processing unit (CPU) 12, and a storage device 14. Each of the ports 10 is connected to a series of network cameras 2 from a monitored area. Each of the ports 10 is further connected to the CPU 12. The CPU 12 is connected to the storage device 14, and the storage device 14 stores an information table. In one embodiment, the information table records a serial number, a media access control (MAC) address, and a monitored area for each of the network cameras 2. The information table further records an Internet protocol (IP) pool that is previously assigned to each monitored area. In one example with respect to FIG. 5, the information table lists the information of the series of network cameras 2.

When an IP request is received from any of the network cameras 2, the CPU 12 captures the corresponding MAC address or addresses, for example, the CPU 12 reads a barcode label stored in the requesting network camera 2, searches an associated IP pool for the requesting network camera 2 in the information table according to the captured MAC address or the area monitored by the network cameras 2, and randomly assigns an IP address from the corresponding IP pool to the requesting network camera 2. For example, if two network cameras 2a and 2b are located in a monitored area “A,” and the IP pool of the area “A” is previously assigned as “192.168.1.1˜192.168.1.255,” the CPU 12 randomly assigns an IP address from the IP pool “192.168.1.1˜192.168.1.255” to the network cameras 2a and 2b, and manages the images captured by the two network cameras according to the IP addresses.

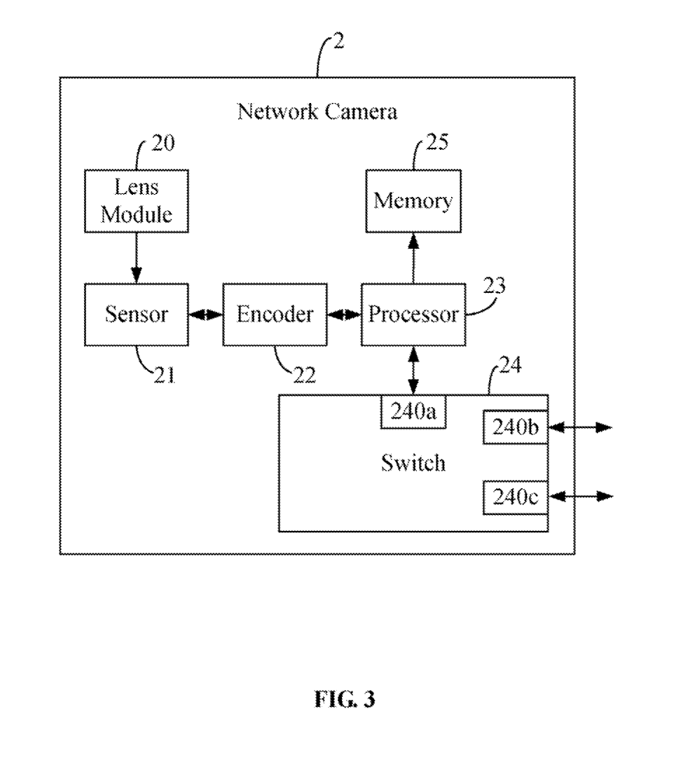

FIG. 3 is a block diagram of one embodiment of a network camera 2 having a switch 24. In the embodiment, each network camera 2 includes a lens module 20, a sensor 21, an encoder 22, a processor 23, and a switch 24, with the components 20-24 connected in series. The lens module 20 is configured for capturing images of the monitored area. The sensor 21 is configured for focusing the lens module 20 on the monitored area. The encoder 22 encodes the captured images, and transmits the encoded images to the processor 23. The processor 23 saves the encoded images in a memory 25. The memory 25 can be a flash memory, for example.

In one embodiment, the switch 24 includes a first port 240a, a second port 240b, and a third port 240c. The first port 240a is connected with the processor 23, and for receiving the processed images. The second port 240b is an extension port of the network camera 2 for connecting to an external device such as another network camera 1, which allows the connection of many network cameras 1 or other devices in series. The third port 240c is connected to a monitor device 3, and transmits the processed images to a monitor device 3 (as shown in FIG. 2). In other embodiments, the switch 24 may have more than one second port 240b, for extending the functions of the network camera 2. The monitor device 3 may be a personal computer, a mobile phone, or a personal digital assistant, for example.

In one embodiment, the first port 240a can be a medium independent interface port or a reduced medium independent interface (MII/RMII) port. The switch 24 can be an ethernet switch. The switch 24 and the processor 23 are connected in series by the MII/RMII port. As illustrated in FIG. 2, the switch 24 can be connected to the AP device 1 via the third port 240c, and transmits the encoded images to the monitor device 3 via the AP device 1. As the port 240b can connect to a video camera or a network camera, the monitor device 3 can monitor one or more network cameras 2 utilizing one network cable 4.

In FIG. 2, four network cables 4 distributed in four areas are given as an example, each of the four network cables 4 connects to the network cameras 2 in a single area through the respective port 240b, and all the captured images from each of the network cameras 2 are transmitted to the AP device 2. Each of the ports 10 receives the encoded images of the monitored area. The CPU 12 receives the encoded images from the ports 10. After an IP request is received from one of the network cameras 2, the CPU 12 searches an associated IP pool for the requesting network camera 2 in the information table according to the captured MAC address or the area monitored by the network camera 2, and assigns an IP address from a corresponding IP pool to the requesting network camera 2 using a dynamic host configuration protocol (DHCP) method, and manages the encoded images according to the IP address.

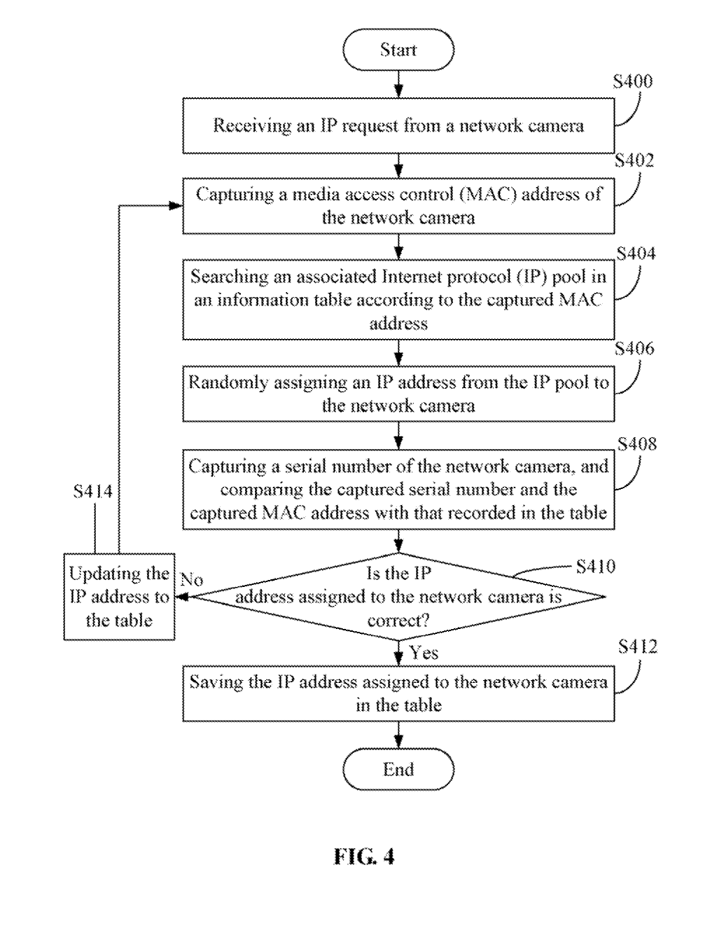

FIG. 4 is a flowchart illustrating one embodiment of a monitor method using the monitor system of FIG. 2. The monitor method can monitor an area by capturing images of the monitored area by using a plurality of network cameras 2 of the monitor system 100, and manages the captured images according to the IP addresses of the network cameras 2.

In step S400, the AP device 1 receives an IP request from one of the network cameras 2. In step S402, the CPU 12 captures the MAC address of the network camera 2, for example, reads a barcode label stored in the network camera 2. In one example with respect to FIG. 5, the information table records a serial number and a MAC address of each of the network cameras 2, an area monitored by each of the network cameras 2, and IP pools previously assigned to the monitored areas.

In step S404, the CPU 12 searches an associated IP pool in the information table according to the captured MAC address or the area monitored by the network camera 2.

In step S406, the CPU 12 randomly assigns an IP address from the IP pool to the network camera 2. For example, if network cameras “2a,” “2b,” “2c,” and “2d” distributed in an area “A” are connected to the port 10a of the AP device 2, and the IP pool of the area “A” is “192.168.1.1˜192.168.1.255” that is recorded in the information table, the CPU 12 searches the IP pool “192.168.1.1˜192.168.1.255” in the information table after receiving an IP request from each of the network cameras 2a-2d, and randomly assigns an IP address to each of the network cameras 2a-2d from the IP pool “192.168.1.1˜192.168.1.255”.

In step S408, the CPU 12 communicates with the network camera 2 according to the IP address, captures the serial number of the network camera 2 (for example, reads a barcode label stored in the network camera 2), and detects whether the IP address assigned to the network camera 2 is correct by comparing the captured serial number and the captured MAC address of the network camera 2 with that recorded in the information table.

If the captured serial number of the network camera 2 is the same as the serial number recorded in the information table, and the captured MAC address of the network camera 2 is the same as MAC address recorded in the information table, the CPU 12 determines that the IP address assigned to the network camera 2 is correct, and the flow enters S412.

If the captured serial number of the network camera 2 is different from the serial number recorded in the information table, or the captured MAC address of the network camera 2 is different from the MAC address recorded in the information table, the CPU 12 determines that the IP address assigned to the network camera 2 is incorrect, and the flow enters S414.

In step S412, the CPU 12 saves the IP address assigned to the network camera 2 in the information table.

In step S414, the CPU 12 updates the IP address assigned to the network camera 2 to the information table, and the flow returns to the step S402.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An access point device, comprising:
a plurality of ports, each of the ports connected to a plurality of network cameras distributed in an area to be monitored;
a storage device configure for storing an information table; and
a central processing unit (CPU) connected to each of the ports and the storage device, and
the CPU configured for receiving an Internet protocol (IP) request from any of the network cameras, capturing a corresponding media access control (MAC) address or addresses, searching an associated IP pool for each of the requesting network cameras in the information table according to the captured MAC address or addresses, and assigning an IP address from the IP pool to each of the requesting network cameras.

2. The access point device as described in claim 1, wherein the information table is operable to record a serial number, a MAC address, and an area monitored by each network camera, and record an IP pool previously assigned to each monitored area.

3. The access point device as described in claim 1, wherein the CPU assigns the IP address using a dynamic host configuration protocol method.

4. The access point device as described in claim 1, wherein the CPU is further configured for communicating with each of the requesting network cameras according the IP addresses, and detecting whether the IP address assigned to each of the requesting network cameras is correct.

5. The access point device as described in claim 4, wherein the CPU is further configured for saving the IP address assigned to each of the requesting network cameras in the information table upon a condition that the IP address assigned to each of the requesting network cameras is correct.

6. The access point device as described in claim 4, wherein the CPU is further configured for updating the IP address to the information table upon a condition that the IP address assigned to the network camera is incorrect.

7. The access point device as described in claim 1, wherein each of the network cameras comprises:
a lens module operable to capturing images of an area to be monitored;
a processor configured for saving the captured images in a memory; and
a switch, comprising:
a first port connected to the processor, and configured for receiving the captured images;
a second port being an extension port of the network camera for connecting to an external device; and
a third port configured for transmitting the captured images to a monitor device.

8. The access point device as described in claim 7, wherein the external device is a network camera.

9. The access point device as described in claim 7, wherein the monitor device is a personal computer, a mobile phone, or a personal digital assistant.

10. The access point device as described in claim 7, wherein the switch is an ethernet switch.

11. A method for monitoring an area using an access point (AP) device, the method comprising:
receiving an IP request from a network camera;
capturing a media access control (MAC) address of the network camera by a central processing unit (CPU) of the AP device;
searching an associated Internet protocol (IP) pool for the network camera in an information table according to the captured MAC address of the network camera; and
assigning an IP address from the IP pool to the network camera by the CPU.

12. The method as described in claim 11, further comprising:
communicating with the network camera according the IP address;
detecting whether the IP address assigned to the network camera is correct by comparing the captured serial number and the captured MAC address of the network camera with that recorded in the information table;
saving the IP address of the network camera in the information table upon a condition that the IP address assigned to the network camera is correct; and
updating the IP address assigned to the network camera to the information table upon a condition that the IP address assigned to the network camera is incorrect.

13. The method as described in claim 11, wherein the CPU assigns the IP address using a dynamic host configuration protocol method.

14. The method as described in claim 11, wherein each of the network cameras comprises:
a lens module operable to capturing images of an area to be monitored;
a processor configured for saving the captured images in a memory; and
a switch, comprising:
a first port connected to the processor, and configured for receiving the captured images;
a second port being an extension port of the network camera for connecting to an external device; and
a third port configured for transmitting the captured images to a monitor device.

15. The method as described in claim 14, wherein the switch is an ethernet switch.

16. The method as described in claim 11, wherein the information table is operable to record a serial number, a MAC address, and an area monitored by each network camera, and record an IP pool previously assigned to each monitored area.
